(19) United States
(12) Patent Application Publication
(10) Pub. No.: US 2025/0278248 A1
(43) Pub. Date: Sep. 4, 2025

(54) SYSTEM, METHOD, AND COMPUTER PROGRAM FOR TRUE RANDOM NUMBER GENERATION

(71) Applicant: TOYOTA JIDOSHA KABUSHIKI KAISHA, Toyota-shi (JP)

(72) Inventor: Caleb MCGARY, Tokyo (JP)

(73) Assignee: TOYOTA JIDOSHA KABUSHIKI KAISHA, Toyota-shi (JP)

(21) Appl. No.: 18/594,592

(22) Filed: Mar. 4, 2024

(51) Int. Cl. G06F 7/58

(52) U.S. Cl. CPC G06F 7/588

(57) ABSTRACT

Provided are system, method, and device for automatically generating random numbers. According to embodiments, the system may include: a memory storage storing computer-executable instructions; and at least one processor communicatively coupled to the memory storage, wherein the at least one processor may be configured to execute the instructions to: perform a startup process for a vehicle; determine a plurality of time stamps when electrical signals flow from a power source to a plurality of segments in each of a plurality of cores of the system during the startup process; and generate a random number based on the determined plurality of time stamps.

### TECHNICAL FIELD

Systems, methods, and computer programs consistent with example embodiments of the present disclosure relate to a true random number generation, and more specifically, relate to the generation of true numbers for vehicle functions.

### BACKGROUND

Modern vehicles are capable of performing a wide range of complex functions, such as generating telemetry data, transmitting and receiving data via the internet, and the like. In order for the vehicles to perform the above functions, said vehicles are inherently connected to an upstream server.

Among such functions, data encryption, authentication, and digital signatures are important aspects for security of such modern vehicles. In general, cryptographic operations are performed for such functions, which involve generating random numbers. For example, random numbers may be used by a vehicle in order to generate dynamic (temporary) keys on startup, may be used for cryptographic exchange when connecting to endpoints outside of the vehicle, and the like.

Here, it may be understood that random numbers refer to true random numbers, which are random numbers generated by an algorithm that uses an entropy (i.e., external unpredictable physical variables such as radioactive decay of isotopes, airwave static, and the like), rather than random numbers generated by a computer algorithm.

For example, one or more truly random values (e.g., radioactive decay of isotopes, airwave static, and the like) may be collected and a portion of such numbers may be used to generate a true random number. In an example, three truly random values may be obtained as 01192935, 83783200, and 28473041, and the last three numbers from said values may be used to generate a true random number as 935200041.

In the related art, the entropies used to generate random numbers for vehicle functions may be user interactions, such as pressure on the steering wheel, speed of the vehicle in a particular geolocation, how the user turns the vehicle at a particular road, and the like. However, in order to generate random numbers based on user interactions, such user interactions may need to be observed and recorded, which may cause issues with privacy laws worldwide related to data collections. To avoid such issues, solutions have been proposed to avoid collecting data on the user during the startup of the vehicle and up to the first 15 minutes of operation of the vehicle.

Nevertheless, the above solutions in the related art may have at least the following shortcomings. Since no data are collected during the startup of the vehicle, truly random variables may not be collected and used as entropies to generate the random numbers. As such, there is a difficulty in ensuring that adequate amount of entropies are collected to generate suitable random numbers for security functions.

Accordingly, there is a need for a system that can generate random numbers for vehicle functions without compromising the user's privacy, while also being able to collect sufficient entropy to generate suitable random numbers for security functions.

### SUMMARY

Example embodiments of the present disclosure automatically generate random numbers based on a plurality of time stamps when electrical signals flow from a power source to a plurality of segments in each of a plurality of cores of the system during a startup process. As such, example embodiments of the present disclosure allows for random numbers to be generated for vehicle functions without compromising the user's privacy, while also being able to collect sufficient entropy to generate suitable random numbers for security functions.

According to embodiments, a system is provided. The system may include: a memory storage storing computer-executable instructions; and at least one processor communicatively coupled to the memory storage, wherein the at least one processor may be configured to execute the instructions to: perform a startup process for a vehicle; determine a plurality of time stamps when electrical signals flow from a power source to a plurality of segments in each of a plurality of cores of the system during the startup process; and generate a random number based on the determined plurality of time stamps.

According to embodiments, the plurality of time stamps may be in nanoseconds or picoseconds.

According to embodiments, the at least one processor may be configured to execute the instructions to generate the random number by: determining one or more portions of each of the determined plurality of time stamps; and combining the one or more portions of each of the determined plurality of time stamps to form the random number.

According to embodiments, the one or more portions of each of the determined plurality of time stamps may include one or more digits of each of the determined plurality of time stamps.

According to embodiments, the at least one processor may be configured to execute the instructions to combine the one or more portions of each of the determined plurality of time stamps by: arranging the one or more portions of each of the determined plurality of time stamps to form the random number; or performing one or more mathematical operations on the one or more portions of each of the determined plurality of time stamps to form the random number.

According to embodiments, the system may include a System On Chip (SoC).

According to embodiments, the plurality of time stamps may be determined using an internal debug meter.

According to embodiments, the plurality of time stamps may be different for every startup processes.

According to embodiments, a method performed by a system is provided. The method may include: performing a startup process for a vehicle; determining a plurality of time stamps when electrical signals flow from a power source to a plurality of segments in each of a plurality of cores of the system during the startup process; and generating a random number based on the determined plurality of time stamps.

According to embodiments, the plurality of time stamps may be in nanoseconds or picoseconds.

According to embodiments, the generating the random number may include: determining one or more portions of each of the determined plurality of time stamps; and combining the one or more portions of each of the determined plurality of time stamps to form the random number.

According to embodiments, the one or more portions of each of the determined plurality of time stamps may include one or more digits of each of the determined plurality of time stamps.

According to embodiments, the combining the one or more portions of each of the determined plurality of time stamps may include: arranging the one or more portions of each of the determined plurality of time stamps to form the random number; or performing one or more mathematical operations on the one or more portions of each of the determined plurality of time stamps to form the random number.

According to embodiments, the system may include a System On Chip (SoC).

According to embodiments, the plurality of time stamps may be determined using an internal debug meter.

According to embodiments, the plurality of time stamps may be different for every startup processes.

According to embodiments, a non-transitory computer-readable recording medium is provided. The non-transitory computer-readable recording medium may have recorded thereon instructions executable by at least one processor of a system to cause the at least one processor to perform a method including: performing a startup process for a vehicle; determining a plurality of time stamps when electrical signals flow from a power source to a plurality of segments in each of a plurality of cores of a system during the startup process; and generating a random number based on the determined plurality of time stamps.

According to embodiments, the plurality of time stamps may be in nanoseconds or picoseconds.

According to embodiments, the generating the random number may include: determining one or more portions of each of the determined plurality of time stamps; and combining the one or more portions of each of the determined plurality of time stamps to form the random number.

According to embodiments, the plurality of time stamps may be determined using an internal debug meter.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a block diagram of example components in a Random Number Generating (RNG) system, according to one or more embodiments;

FIG. 2A illustrates an example architecture of a Random Number Generating (RNG) system, according to one or more embodiments;

FIG. 2B illustrates an example architecture of a core in a Random Number Generating (RNG) system, according to one or more embodiments; and

FIG. 3 illustrates a flow diagram of an example method for generating random numbers, according to one or more embodiments.

### DETAILED DESCRIPTION

The following detailed description of example embodiments refers to the accompanying drawings. The same reference numbers in different drawings may identify the same or similar elements.

The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]” are to be understood as including only A, only B, or both A and B.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the threshold tuning system of the present disclosure, according to one or more embodiments, are provided in the following.

### Example System Architecture

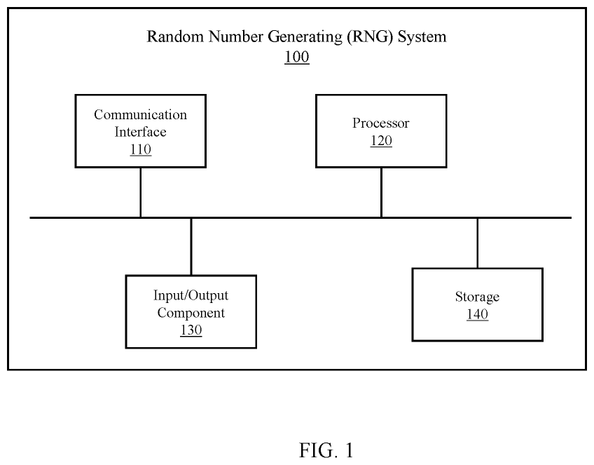

FIG. 1 illustrates a block diagram of example components in a Random Number Generating (RNG) system 100, according to one or more embodiments.

The RNG system may include a system, a platform, a module, or the like, which may be configured to perform one or more operations or actions for generating a random number. According to embodiments, the RNG system 100 may comprise a chip installed in a vehicle. For example, the RNG system 100 may comprise a System on Chip (SoC) that is installed in a vehicle and that is communicatively coupled to one or more components of the vehicle, such as Electronic Control Units (ECUs) and the like.

As illustrated in FIG. 1, the RNG system 100 may include at least one communication interface 110, at least one processor 120, at least one input/output component 130, and at least one storage 140, although it can be understood that the RNG system 100 may include more or less components than as illustrated in FIG. 1, and/or the components may be arranged in a manner different from FIG. 1, without departing from the scope of the present disclosure.

The communication interface 110 may include at least one transceiver-like component (e.g., a transceiver, a separate receiver and transmitter, a bus, etc.) that enables the components of the RNG system 100 to communicate with each other and/or to communicate with one or more components external to the RNG system 100, such as via a wired connection, a wireless connection, or a combination of wired and wireless connections.

For example, the communication interface 110 may couple the processor 120 to the storage 140 to thereby enable them to communicate and to interoperate with each other in performing one or more operations. As another example, communication interface 110 may couple the RNG system 100 (or one or more components included therein), so as to enable them to communicate and to interoperate with each other.

According to one or more embodiments, the communication interface 110 may include one or more application programming interfaces (APIs) which allow the RNG system 100 (or one or more components included therein) to communicate with one or more software applications.

The input/output component 130 may include at least one component that permits the RNG system 100 to receive information and/or to provide output information. It can be understood that, in some embodiments, the input/output component 130 may include at least one input component (e.g., a touch screen display, a button, a switch, a microphone, a sensor, etc.) and at least one output component (e.g., a display, a speaker, one or more light-emitting diodes (LEDs), etc.), each of which may be separated from each other.

The storage 140 may include one or more storage mediums suitable for storing data, information, and/or computer-executable instructions therein. According to embodiments, the storage 140 may include at least one memory storage, such as a random access memory (RAM), a read only memory (ROM), and/or another type of dynamic or static storage device (e.g., a flash memory, a magnetic memory, and/or an optical memory) that stores information and/or instructions for use by the processor 120. Additionally or alternatively, the storage 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage 140 may be configured to store information, such as raw data, metadata, or the like. Additionally or alternatively, the storage 140 may be configured to store one or more information associated with one or more operations performed by the processor 120. For example, the storage 140 may store information defining the historical operation(s) performed by the processor 120 to generate random numbers, one or more results of operations performed by the processor 120, or the like. Further, the storage 140 may store data or information required in generating random numbers.

In some implementations, the storage 140 may include a plurality of storage mediums, and the storage 140 may be configured to store a duplicate or a copy of at least a portion of the information in the plurality of storage mediums, for providing redundancy and for backing-up the information or the associated data. Furthermore, the storage 140 may also store computer-readable or computer-executable instructions which, when being executed by one or more processors (e.g., processor 120), causes the one or more processors to perform one or more actions/operations described herein.

The processor 120 may include at least one processor capable of being programmed or being configured to perform a function(s) or an operation(s) described herein. For example, the processor 120 may be configured to execute computer-executable instructions stored in at least one storage medium or a memory storage (e.g., storage 140, etc.) to thereby perform one or more actions or one or more operations described herein.

According to embodiments, the processor 120 may be configured to receive (e.g., via the communication interface 110, via the input/output component 130, etc.) one or more signals and/or one or more user inputs defining one or more instructions for performing one or more operations. Further, the processor 120 may be implemented in hardware, firmware, or a combination of hardware and software. For example, processor 120 may include at least one of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

According to embodiments, the processor 120 may be configured to collect, to extract, and/or to receive one or more information (in the form of signal or data, etc.), and to process the received one or more information to thereby generate random numbers.

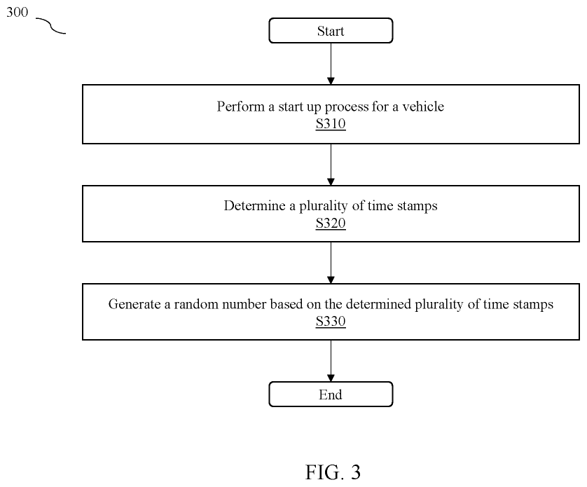

Descriptions of several example operations which may be performed by the processor 120 of the RNG system 100 for generating random numbers are provided below with reference to FIG. 3.

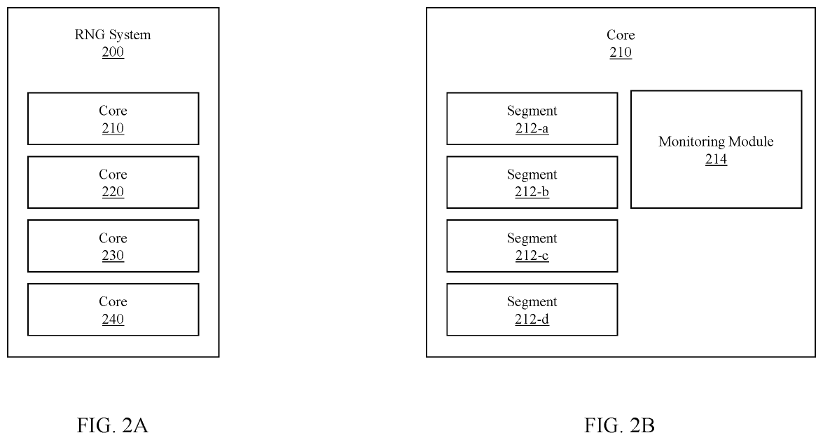

FIG. 2A illustrates an example architecture of an RNG system 200, according to one or more embodiments. The RNG system 200 may correspond to the RNG system 100 in FIG. 1, thus the features associated with the RNG system 200 and the RNG system 100 may be similarly applicable to each other, unless being explicitly described otherwise.

As illustrated in FIG. 2A, the RNG system 200 may include a plurality of cores: core 210, core 220, core 230, and core 340. Each of the plurality of cores 210, 220, 230, and 240 may comprise a processor core, which may include one or more of microcontroller, microprocessor, digital signal processor (DSP), an application-specific instruction set processor (ASIP), and the like.

FIG. 2B illustrates an example architecture of core 210 in the RNG system 200, according to one or more embodiments. It may be understood that cores 220, 230, and 240 may have a similar architecture, unless being explicitly described otherwise.

As illustrated in FIG. 2B, the core 210 may include a plurality of segments: segment 212-a, segment 212-b, segment 212-c, and segment 212-d; and a monitoring module 214. The plurality of segments may refer to a plurality of physical sections/portions that form the core. According to embodiments, each of the plurality of segments may include one or more components of a core. For example, the plurality of segments may include one or more of control unit, arithmetic-logic unit, memory, and the like of a processor core. According to embodiments, the monitoring module 214 may be configured to monitor and track a startup (power on) process of the RNG system 200. For example, the monitoring module 214 may comprise an SoC's internal debug meter that is configured to monitor and track a startup process of the SoC during the vehicle startup.

According to embodiments, the RNG system 200 may include or be communicatively coupled to additional components that allows the monitoring module 214 monitor and track a startup process of the system. For example, the RNG system 200 may include a high grade camera and/or an electroencephalogram as part of an internal diagnostics of the SoC.

It can be understood that the configurations illustrated in FIG. 2A and FIG. 2B are simplified for descriptive purposes, and are not intended to limit the scope of the present disclosure in any way. Specifically, in practice, the number of the plurality of cores and the number of the plurality of segments can be any number. Further, it can be understood that the RNG system 200 may include more or less components than as illustrated in FIG. 2A and FIG. 2B, and/or the components may be arranged in a manner different from FIG. 2A and FIG. 2B, without departing from the scope of the present disclosure

### Example Operations for Generating a Random Number in the Present Disclosure

In the following, several example operations performable by the RNG system of the present disclosure are described with reference to FIG. 3.

FIG. 3 illustrates a flow diagram of an example method 300 for generating random numbers, according to one or more embodiments. One or more operations in method 300 may be performed by at least one processor (e.g., processor 120) of the RNG system.

As illustrated in FIG. 3, at operation S310, the at least one processor may be configured to perform a startup process for a vehicle. The startup process may comprise powering on various components of the vehicle, including a plurality of segments of each of a plurality of cores of the system. The method then proceeds to operation S320.

At operation S320, the at least one processor may be configured to determine a plurality of time stamps when electrical signals flow from a power source to a plurality of segments in each of a plurality of cores of the system during the startup process. According to embodiments, the plurality of time stamps may comprise a time between the start of the startup process and the time when electrical signals reach the plurality of segments in each of the plurality of cores. Further, the plurality of time stamps may be in nanoseconds or picoseconds.

For example, returning to FIG. 2B, the times between the start of the startup process and the time when electrical signals reach segment 212-a, segment 212-b, segment 212-c, and segment 212-d of core 210 may be 1265 picoseconds, 1326 picoseconds, 2854 picoseconds, and 1124 picoseconds respectively. Accordingly, the plurality of time stamps may comprise 1265 picoseconds, 1326 picoseconds, 2854 picoseconds, and 1124 picoseconds.

According to embodiments, the plurality of time stamps may be different for every startup processes.

It may be understood that, when a vehicle powers up during the startup process, electricity may flow from a power source to the various components of the vehicle, including the plurality of segments of each of the plurality of cores of the system, where each of the plurality of segments may power up individually. Here, the time when electrical signals flow from the power source to each of the plurality of segments will be different each time the vehicle powers up, despite physical wirings between the components and their power on order remaining the same. For example, while the time between the start of the startup process and the time when electrical signals reach segment 212-a is 1265 picoseconds in the above example, such time may be different during the next startup process. As such, the plurality of time stamps may be used as entropies to generate random numbers.

According to embodiments, the plurality of time stamps may be determined using a monitoring module of the RNG system. The monitoring module may include, for example, an internal debug meter included in an SoC. Further, according to embodiments, the plurality of time stamps may be stored in a memory. The method then proceeds to operation S330.

At operation S330, the at least one processor may be configured to generate a random number based on the determined plurality of time stamps.

According to embodiments, the at least one processor may be configured to generate the random number based on the determined plurality of time stamps by determining one or more portions of each of the determined plurality of time stamps. The one or more portions of each of the determined plurality of time stamps may include, for example, one or more digits of each of the determined plurality of time stamps.

For example, the at least one processor may be configured to determine a last 3 digits of each of the determined plurality of time stamps, where the determined last 3 digits of each of the determined plurality of time stamps may be 265, 326, 854, and 124 for segment 212-a, segment 212-b, segment 212-c, and segment 212-d of core 210, respectively. In another example, the at least one processor may be configured to determine a first and last digits of each of the determined plurality of time stamps, where the determined first and last digits of each of the determined plurality of time stamps may be 15, 16, 24, and 14 for segment 212-a, segment 212-b, segment 212-c, and segment 212-d of core 210, respectively.

According to embodiments, the at least one processor may be configured to generate the random number based on the determined plurality of time stamps further by combining the one or more portions of each of the determined plurality of time stamps to form the random number.

According to embodiments, the at least one processor may be configured to combine the one or more portions of each of the determined plurality of time stamps to form the random number by arranging the one or more portions of each of the determined plurality of time stamps to form the random number. For example, the at least one processor may be configured to arrange the last 3 digits of each of the determined plurality of time stamps to form the random number as 265326854124.

According to embodiments, the at least one processor may be configured to combine the one or more portions of each of the determined plurality of time stamps to form the random number by performing one or more mathematical operations on the one or more portions of each of the determined plurality of time stamps to form the random number. For example, the at least one processor may be configured to multiply the last 3 digits of each of the determined plurality of time stamps to form the random number as 9148355440.

It may be understood that the above examples provided in relation to the time stamps of segment 212-a, segment 212-b, segment 212-c, and segment 212-d of core 210 are simplified for descriptive purposes, and are not intended to limit the scope of the present disclosure in any way. In particular, the time stamps of segments of other cores of the RNG system may also be used.

In this regard, since the random number is generated based on the time stamps when electrical signals flow from a power source to a plurality of segments in each of a plurality of cores of the system, rather than based on user interactions, the random number can be generated shortly after boot without compromising the user's privacy. Further, since the time stamps when electrical signals flow from the power source to the plurality of segments in each of the plurality of cores are different for every startup process and is in nanoseconds/picoseconds, sufficient entropies can be collected to generate suitable random numbers for security functions.

Accordingly, the above process may also allow the vehicle to perform Over-the-Air connections immediately after start, since the keys can be generated from the random numbers and available for use quickly after start.

Upon performing operation S330, the method 300 may be ended or be terminated. Alternatively, method 300 may return to operation S310, such that the at least one processor may be configured to repeatedly perform, for at least a predetermined amount of time, the performing the startup process (at operation S310), the determining the plurality of time stamps (at operation S320), and the generating the random number (at operation S330).

For instance, the user may start his or her vehicle for the first time, and the at least one processor may be configured to perform the performing the startup process (at operation S310), the determining the plurality of time stamps (at operation S320), and the generating the random number (at operation S330). Then, the user may start his or her vehicle for the second time, and the at least one processor may be configured to repeat the performing the startup process (at operation S310), the determining the plurality of time stamps (at operation S320), and the generating the random number (at operation S330). Here, it may be understood that the random number generated when the user starts his or her vehicle for the first time and the random number generated when the user starts his or her vehicle for the second time may be different.

### Various Aspects of Embodiments

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a memory storage storing computer-executable instructions; and
at least one processor communicatively coupled to the memory storage, wherein the at least one processor is configured to execute the instructions to:
perform a startup process for a vehicle;
determine a plurality of time stamps when electrical signals flow from a power source to a plurality of segments in each of a plurality of cores of the system during the startup process; and
generate a random number based on the determined plurality of time stamps.

2. The system according to claim 1, wherein the plurality of time stamps are in nanoseconds or picoseconds.

3. The system according to claim 1, wherein the at least one processor is configured to execute the instructions to generate the random number by:
determining one or more portions of each of the determined plurality of time stamps; and
combining the one or more portions of each of the determined plurality of time stamps to form the random number.

4. The system according to claim 3, wherein the one or more portions of each of the determined plurality of time stamps comprise one or more digits of each of the determined plurality of time stamps.

5. The system according to claim 3, wherein the at least one processor is configured to execute the instructions to combine the one or more portions of each of the determined plurality of time stamps by:
arranging the one or more portions of each of the determined plurality of time stamps to form the random number; or
performing one or more mathematical operations on the one or more portions of each of the determined plurality of time stamps to form the random number.

6. The system according to claim 1, wherein the system comprises a System On Chip (SoC).

7. The system according to claim 1, wherein the plurality of time stamps are determined using an internal debug meter.

8. The system according to claim 1, wherein the plurality of time stamps are different for every startup processes.

9. A method performed by a system, comprising:
performing a startup process for a vehicle;
determining a plurality of time stamps when electrical signals flow from a power source to a plurality of segments in each of a plurality of cores of the system during the startup process; and
generating a random number based on the determined plurality of time stamps.

10. The method according to claim 9, wherein the plurality of time stamps are in nanoseconds or picoseconds.

11. The method according to claim 9, wherein the generating the random number comprises:
determining one or more portions of each of the determined plurality of time stamps; and
combining the one or more portions of each of the determined plurality of time stamps to form the random number.

12. The method according to claim 11, wherein the one or more portions of each of the determined plurality of time stamps comprise one or more digits of each of the determined plurality of time stamps.

13. The method according to claim 11, wherein the combining the one or more portions of each of the determined plurality of time stamps comprises:
arranging the one or more portions of each of the determined plurality of time stamps to form the random number; or
performing one or more mathematical operations on the one or more portions of each of the determined plurality of time stamps to form the random number.

14. The method according to claim 9, wherein the system comprises a System On Chip (SoC).

15. The method according to claim 9, wherein the plurality of time stamps are determined using an internal debug meter.

16. The method according to claim 9, wherein the plurality of time stamps are different for every startup processes.

17. A non-transitory computer-readable recording medium having recorded thereon instructions executable by at least one processor to cause the at least one processor to perform a method comprising:
performing a startup process for a vehicle;
determining a plurality of time stamps when electrical signals flow from a power source to a plurality of segments in each of a plurality of cores of a system during the startup process; and
generating a random number based on the determined plurality of time stamps.

18. The non-transitory computer-readable recording medium according to claim 17, wherein the plurality of time stamps are in nanoseconds or picoseconds.

19. The non-transitory computer-readable recording medium according to claim 17, wherein the generating the random number comprises:
determining one or more portions of each of the determined plurality of time stamps; and
combining the one or more portions of each of the determined plurality of time stamps to form the random number.

20. The non-transitory computer-readable recording medium according to claim 17, wherein the plurality of time stamps are determined using an internal debug meter.
